(19) United States
(12) Patent Application Publication
(10) Pub. No.: US 2015/0252603 A1
(43) Pub. Date: Sep. 10, 2015

(54) SUPPORTING COUNTER-FRAME FOR SLIDING DOORS OF FRIDGE CABINETS

(71) Applicant: CIANETTI S.R.L., San Pier d'Isonzo (IT)

(72) Inventor: Alessandro Cianetti, San Pier d'Isonzo (IT)

(21) Appl. No.: 14/425,406

(22) PCT Filed: Sep. 5, 2013
(86) PCT No.: PCT/IT2013/000233

§ 371 Date: Mar. 3, 2015

(30) Foreign Application Priority Data
Sep. 7, 2012 (IT) GO2012A000008

(51) Int. Cl. E05D 13/00; F25D 23/02; E06B 3/46; E06B 5/00; E05D 15/06; E05F 1/02

(52) U.S. Cl. CPC E05D 13/10; E05D 15/0652; E05D 15/063; E05F 1/025; E06B 3/4645; E06B 5/00; F25D 23/021; F25D 23/028; E05F 2017/005

(57) ABSTRACT

A supporting counter-frame for sliding doors with an automatic closing system comprising, for each sliding door (2), a first pulley (11), a second pulley (12), a counterweight (15) equipped with a third pulley (16) and a motion transmission cable (28); said counterweight (15) is housed within a vertical section bar (4) of the counter-frame (1); one end of the cable (28) is fixed to a trolley (24) of a sliding door (2) and slides till the first pulley (11) along the sliding direction of the sliding door (2), from the first pulley (11) to the second pulley (12) horizontally and orthogonally to the sliding movement of the sliding door (2) and finally from the second pulley (12) to the third pulley (16) of the counterweight (15) and again to the second pulley (12) vertically and orthogonally to the sliding movement of the sliding door (2).

### FIELD OF THE INVENTION

This invention refers to a supporting counter-frame for sliding doors of fridge cabinets comprising an automatic closing system, specifically the fridge cabinets used in sales outlets to display and sell packaged food, drinks and other foodstuffs which shall be kept at a controlled negative or positive temperature.

### STATE OF THE ART

The sliding doors of the fridge cabinets intended for the sale of foodstuffs shall always remain closed to save frigories and to constantly control the inner temperature of the cabinet in order to prevent the food from warming up and from thus losing its flavour or even deteriorating.

The sliding doors are supported by a peripheral supporting counter-frame delimiting the access opening to the refrigerated space.

Each sliding door is composed of a frame encircling a transparent glass or plastic plate or an insulating blind plate. The doors slide freely while resting on lower guides of the lower section bar of the counter-frame below or while being supported by trolleys sliding on the upper section bar of the supporting counter-frame above.

The doors can be unconsciously left open by customers after the desired food has been removed from the fridge cabinet. To prevent this from happening, different solutions have been adopted to enable the automatic closing of said doors. These solutions are well-known.

For example, one of the known closing systems is disclosed in WO1993018260, which describes a movable closure having a fixed element defining a passageway, the fixed element being mounted to the closure, and a closure return element. The closure return element has an intermediate segment oriented to pass through the passageway of the fixed element. A rotatable braking wheel is mounted close to the right hand corner, on a right hand door, on the top horizontal rail of the door. An elastic element is coupled to the door frame and to the top rail of the door so for engaging braking wheel. The elastic element may be a cord. A second rotatable pulley wheel is mounted close to the left hand corner, on a right hand door, on the top horizontal rail of the door. The elastic element extends from the door frame through the braking wheel, and around the second pulley wheel to an adjustment block mounted to the top horizontal rail of the door.

Other automatic closing systems for sliding doors also use elastic elements connecting each door to an upright of the counter-frame. The door slides back to the closed position thanks to the restoring force of the elastic element.

Other automatic closing systems use a counterweight. DE 299 20 016 U1 describes a frame for sliding doors in which said doors slide on trolleys located on the upper transom of the counter-frame. A cable going through a pulley located at the contact point between upright and transom is fastened to the trolley being closest to the an upright. The second end of the cable is fixed to a counterweight housed in a cylinder. The counterweight pulls back the door thanks to its weight force. The air exiting from the cylinder due to the movement of the counterweight is controlled by means of a valve.

WO 2006/113773 describes a self-closing sliding door assembly, in which a cable is fixed to a sliding door. The cable goes through a first pulley located at the contact point between the upright and the transom of the counter-frame and a second pulley arranged orthogonally to the first pulley. The second pulley is located outside the frame. The second end of the cable is fixed to a counterweight.

WO 97/23701 describes an apparatus for automatic closing of sliding doors similar to the one described in WO 2006/113773 and equipped with two pulleys, one orthogonal to the other. One end of the cable going through the two pulleys is fixed to the door being furthest from the upright to which the pulleys are connected. The second end of the cable is fixed to a counterweight sliding within a cylinder equipped with an air regulating valve.

Nonetheless, conventional automatic closing systems for sliding doors present some recurring defects:

they impart a relatively constant acceleration to the door, causing a violent collision of the door against the upright of the counter-frame, when the door is closed, thus making it possible for the door to bounce back from the upright after having hit it;

the restoring force of the closing mechanism can be maladjusted; the force of the closing mechanism is not sufficient to pull the sliding door back into the full closed position or the force is so over-dimensioned that the closing is too quick, which might be dangerous for customers and, finally, might damage the fridge cabinet;

in the systems with a counterweight, this slides within a cylinder located at the side of the upright of the counter-frame, which reduces the view of the displayed goods;

in the systems with a counterweight, the cylinder housing the counterweight must be longer than the maximum stroke of the door.

The building systems of conventional counter-frames and frames for sliding doors also present some defects:

sometimes they are so complex that it is difficult to remove the sliding door from the counter-frame, which makes it difficult to clean the area between the counter-frame and the frames of the doors; this area must be cleaned regularly, both for health reasons and to ensure that the fridge cabinet looks clean to the customers;

the section bars forming the traditional counter-frame and frame are bulky and hinder the optimal view of the displayed goods.

### SUMMARY OF THE INVENTION

The aim of this invention is to produce a supporting counter-frame comprising an automatic closing system for sliding doors able to solve the above-mentioned problems.

Another purpose is to produce an improved automatic closing system in order to avoid part of the above-mentioned defects.

These and other aims are achieved by this supporting counter-frame comprising an automatic closing system for sliding doors. Each supporting counter-frame is composed of an upper section bar, two vertical section bars and a lower section bar. Each section bar composing the counter-frame has first guides, parallel to its longitudinal axis, along the surface facing the edges of the refrigerated space. The vertical section bars and the upper section bar are connected to each other by means of connecting angle joints, while the vertical section bars and the lower section bar are connected to each other by means of angle brackets. Both the upper connecting angle joints and the lower angle brackets are equipped with arms inserted into the above-mentioned first guides of the section bars composing the counter-frame and fixed to the section bars themselves.

The upper supporting section bar is made of metal and its profile is dimensioned so as to be able to support the weight of the sliding doors. Inside the upper section bar two arms dividing its inner space into an upper chamber and a lower chamber, which communicate with each other. The upper section bar, moreover, has further second guides, parallel to each other as well as to the longitudinal axis of the upper section bar on the side facing the customer, which are engaged by elements of an upper covering section bar which covers the gaps between the upper supporting section bar and the sliding doors.

The vertical section bars composing the uprights of the perimeter supporting counter-frame are made of plastic or metal. Each vertical section bar has further second guides, parallel to each other as well as to the longitudinal axis of the vertical section bar itself, on the surface facing the edges of the access opening to the refrigerated space. Said second guides are deeper than the first guides of the vertical section bar and house pins which can connect two adjoining counter-frames to each other.

Each vertical section bar has further third guides, parallel to its longitudinal axis, on the surface facing the access opening to the refrigerated space. A vertical covering section bar is inserted into the vertical section bar by means of said third guides. The vertical covering section bar and the walls of the vertical section bar delimit a chamber. Said chamber of the vertical section bar only takes up part of the inner space of the vertical section bar, while the remaining part of the inner space of the vertical section bar is an open chamber. Said chamber and said open chamber are parallel to the longitudinal axis of the vertical section bar and are arranged one in front of the other, if observed by someone standing in front of the fridge cabinet. The two vertical section bars of each counter-frame are mounted reversely, so that the arrangement of the chambers is also reversed.

The lower section bar is made of plastic or metal and has further second guides, parallel to its longitudinal axis, developing along its sides facing the customer and the inside of the refrigerated space. A lower covering section bar equipped with perimetric fins, which are housed by means of a snap-in mechanism in the side guides of the lower section bar of the counter-frame, is inserted above the lower section bar of the counter-frame itself. Along its upper side, said lower covering section bar has guides which guide the sliding doors along their sliding axis. The side guides of the lower section bar of the counter-frame are over-dimensioned if compared with the size of the fins of the lower covering section bar. The lower section bar of the frame of each sliding door is equipped with anti-friction slides. The lower section bar of the sliding door and the corresponding slides slide along the guides located on the upper side of the lower covering section bar of the counter-frame.

The upper section bar of the counter-frame, moreover, is equipped with elastic stop buffers. Said buffers enable the sliding door to stop at the end of its stroke, even in case the sliding door should be closed with a higher strength than necessary.

The counter-frame delimits the access opening to the refrigerated space and encircles its perimeter. If the access opening to the refrigerated space is broad, more counter-frames, each of which has its own doors, can be used in the same fridge cabinet. The vertical section bars of two adjoining counter-frames can indeed be connected to each other by placing them precisely side by side and by exerting pressure to insert the above-mentioned pins into the vertical section bars themselves.

The supporting counter-frame supports two sliding doors, parallel to each other and sliding freely, which are supported by trolleys above, fixed to the brackets of the upper section bar of the door, which slide by means of wheels on the upper section bar of the counter-frame and are guided below by the lower guides of the lower covering section bar of the counter-frame.

The automatic closing system for sliding doors of the counter-frame comprises, for each sliding door, a first pulley and a second pulley, the rotation axles of which are orthogonal to each other, a counterweight equipped with a third pulley and a motion transmission cable.

The first pulley and the second pulley are housed in a box and rotate on the above-mentioned rotation axles fixed to the box itself. The box housing the first pulley and the second pulley is housed in and fixed to a connecting angle joint linking the upper section bar to a vertical section bar of the counter-frame. Each counterweight and its third pulley are housed in a vertical section bar of the counter-frame and slide within it. Each counterweight and its third pulley can be housed in the chamber of the vertical section bar delimited by the above-mentioned vertical covering section bar and by the walls of the vertical section bar.

One end of the motion transmission cable is fixed to the trolley closest to the sliding door being closest to the box containing the first pulley and the second pulley and slides from the trolley to the first pulley along the sliding direction of the sliding door. The motion transmission cable slides from the first pulley to the second pulley horizontally and orthogonally to the sliding movement of the sliding door. Finally, the cable slides from the second pulley to the pulley of the counterweight and again to the second pulley vertically and orthogonally to the sliding movement of the sliding door. The other end of the cable is fixed to the axle of the second pulley.

A rotating locking lever of the doors is pivoted onto the upper bracket being furthest from the counterweight of the sliding door. Said locking lever of the doors facilitates the loading and unloading of goods into and from the refrigerated space of the fridge cabinet.

The use of the third pulley, with which the counterweight is equipped, makes it possible to halve the stroke of the counterweight itself, thus making it possible to use the automatic closing system even in counter-frames with a limited height. In a conventional frame, the height of the upright equals the sum of the maximum stroke of the installed sliding door plus a certain safety length for stroke end and air valve. In this counter-frame, instead, the height of the upright is slightly more than half of the maximum stroke of the sliding door. No safety length is necessary, as there is no air valve.

Moreover, the fact that the cable goes through the pulley of the counterweight enables the cable itself to slide effortlessly and reduces the weight and the falling speed of the counterweight.

As mentioned above, the counterweight slides freely in a vertical section bar of the counterweight or in its chamber without any air-retaining element. The counterweight, therefore, does not act as piston and it is hence useless to equip the vertical section bar with an exhaust air valve. This prevents damages to the system due to the wear and tear of the air gasket or to the obstruction of the valve, which would prevent the door from being pulled back.

As mentioned above, the chamber in which the counterweight slides and the open chamber of each vertical section bar, which the sliding door partly enters when it comes to a stop, are arranged one in front of the other, if observed by someone standing in front of the fridge cabinet. This makes it possible to obtain a counter-frame in which the vertical section bars have a limited width, thus greatly improving the view of the displayed goods.

The box containing part of the closing system of each sliding door can easily be extracted from the connecting joint housing it, which makes its maintenance or substitution in case of failure easier.

When the perimeter supporting counter-frame is assembled, it is perfectly orthogonal, easy to handle and sturdy, ready to be mounted onto the perimeter of the opening of the display space of the fridge cabinet.

Thanks to the easy and precise assembly between the vertical section bars of the counter-frame, the whole edge of the display space can be used, as smaller upper and lower section bars are used. The length of each counter-frame preferably has a value representing a multiple of currently available commercial sizes. This prevents the need to produce frames with one-piece upper and lower section bars, which would be extremely bulky when handled and mounted as well as stored and shipped.

Thanks again to the easy and precise assembly between the section bars of the counter-frame, this counter-frame can be mounted in a very short time.

The upper covering section bar covers the gaps between the upper section bar of the counter-frame and the sliding doors, thus preventing dust or insects from entering as well as fingers from being inserted during the opening process. Said upper covering section bar also covers the upper section bar of the counter-frame, which is made of metal, i.e. a different material than the other section bars of the counter-frame, thus making the perimeter appearance of the frame uniform.

The vertical covering section bar can be detached to inspect the pulley of the counterweight and, if necessary, to substitute the motion transmission cable.

The lower covering section bar can easily be detached from the lower section bar of the counter-frame, which makes it easier to clean the lower section bars.

The presence of anti-friction slides on the lower section bar of the frame of each sliding door prevents friction which, in case of misalignment of the sliding door, would prevent it from returning into place correctly.

### SHORT DESCRIPTION OF THE DRAWINGS

The object of this patent is completely illustrated in each relevant feature by the description of a specific embodiment, preferred but not exclusive, of the supporting counter-frame for sliding doors of fridge cabinets comprising an automatic closing system, depicted by way of example, but with no limitations, in the attached drawings, in which:

FIG. 1 shows a front view of a fridge cabinet with four sliding doors;

FIG. 2 shows a perspective view of the automatic closing system of each sliding door;

FIG. 3 shows another perspective view of the same automatic closing system;

FIG. 4 shows an exploded view of the section bars composing a counter-frame and two frames;

FIG. 5 shows a perspective view of part of the upper section bar and of a vertical section bar of a counter-frame, of the upper connecting joint and of the upper covering section bar;

FIG. 6 shows a cross section of a vertical section bar of the counter-frame;

FIG. 7 shows a cross section of the upper section bar of the counter-frame and of the upper covering section bar;

FIG. 8 shows a perspective view of part of the vertical section bar, of the lower section bar of the counter-frame and of the bracket connecting them;

FIG. 9 shows a perspective view of the lower section bar of the counter-frame and of the lower covering section bar;

FIG. 10 shows a cross section of the counter-frame and of a closed sliding door;

FIG. 11 shows a cross section of a sliding door;

FIG. 12 shows a cross section of the lower section bars of the counter-frame and of the lower part of two doors;

FIG. 13 shows a perspective view of a bracket equipped with trolley for the sliding of one door;

FIG. 14 shows a perspective view of a bracket, equipped with trolley for the sliding of one door, provided with a locking/unlocking lever;

FIG. 15 shows a front view of the counter-frame and of the brackets equipped with trolleys for the sliding of the doors;

FIG. 16 shows a perspective view of part of a frame of a sliding door equipped with a bracket with door locking/unlocking lever in operating position;

FIG. 17 shows a front view with partial longitudinal section of one upper corner of the counter-frame emphasizing a stop buffer;

FIG. 18 shows a perspective view of a stop buffer;

FIG. 19 shows a perspective view of three counter-frames according to the invention and of the corresponding six sliding doors.

### DETAILED DESCRIPTION OF ONE EXECUTION FORM

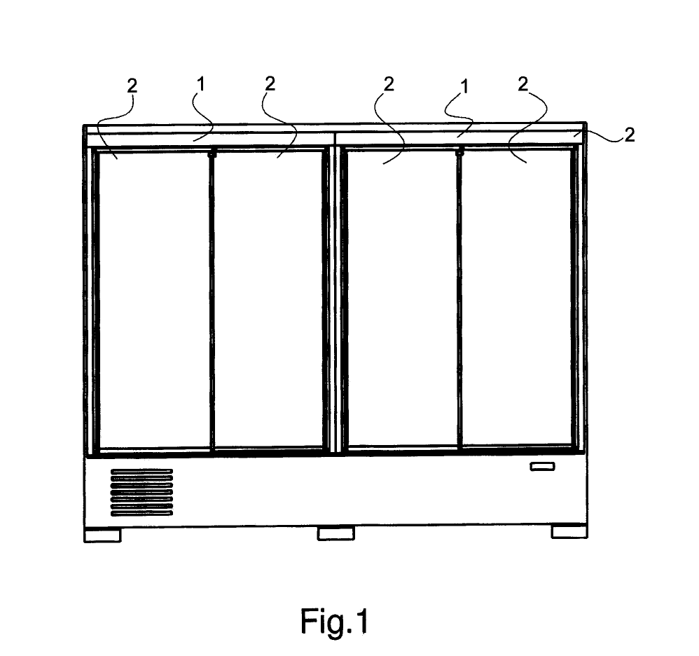

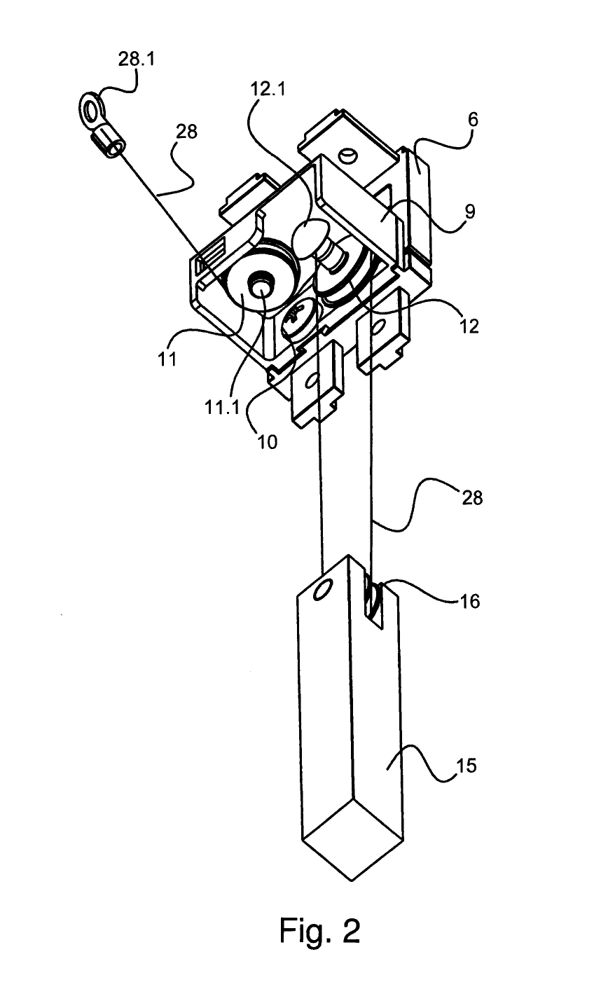

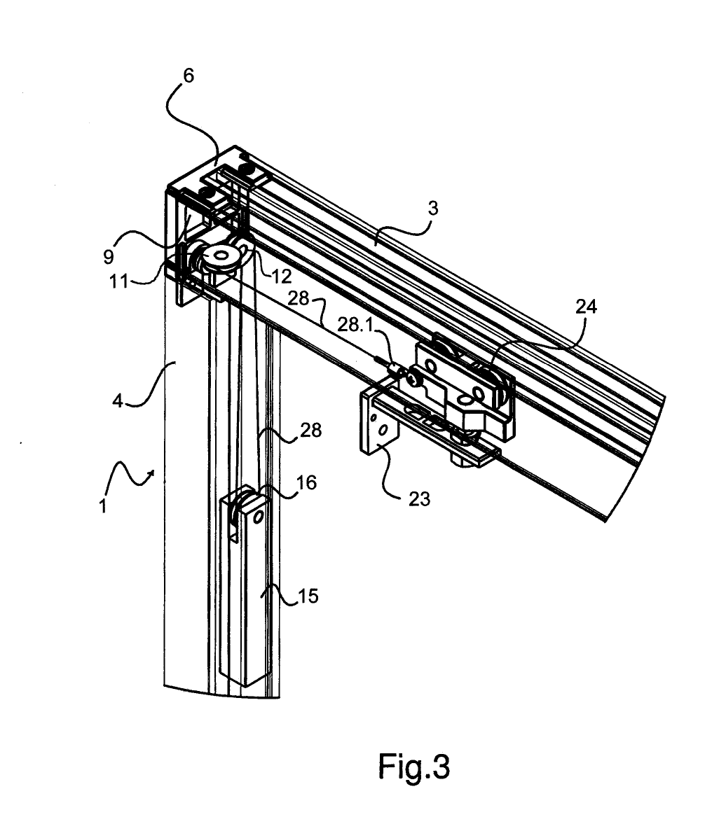

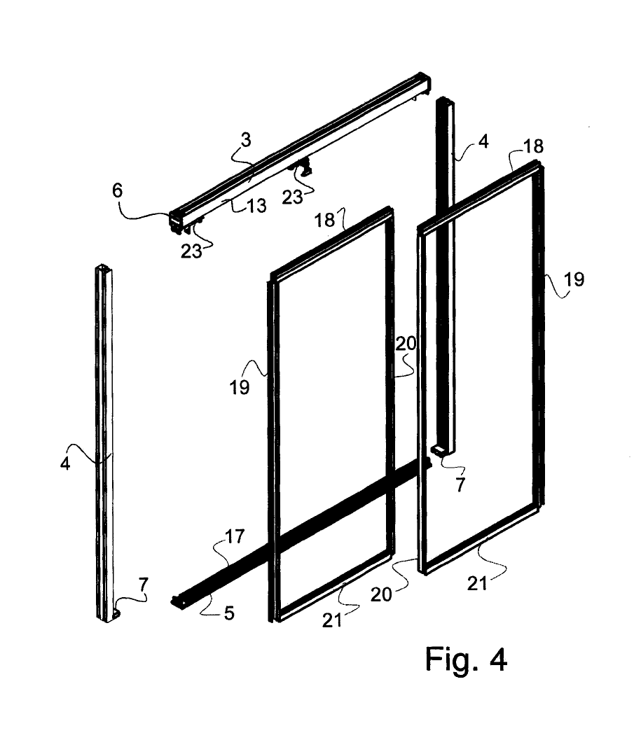

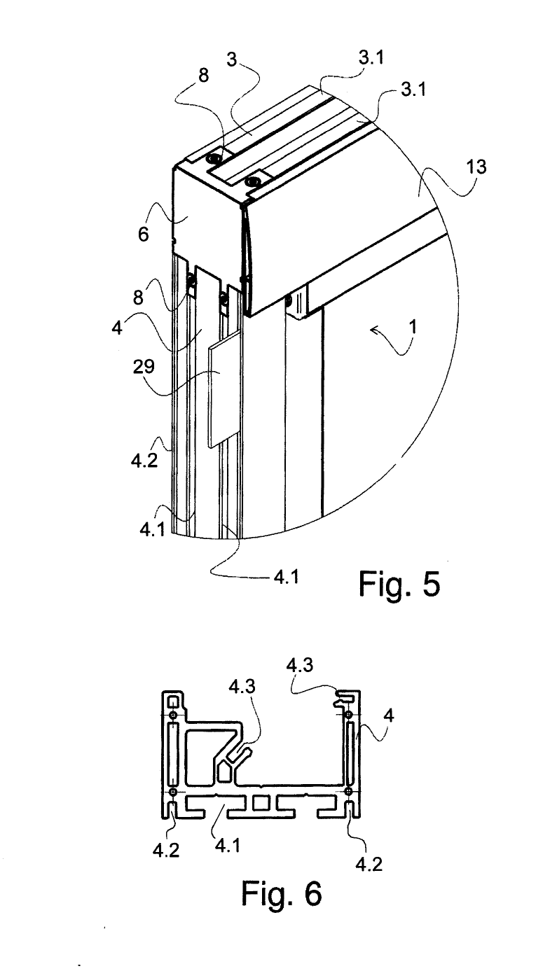

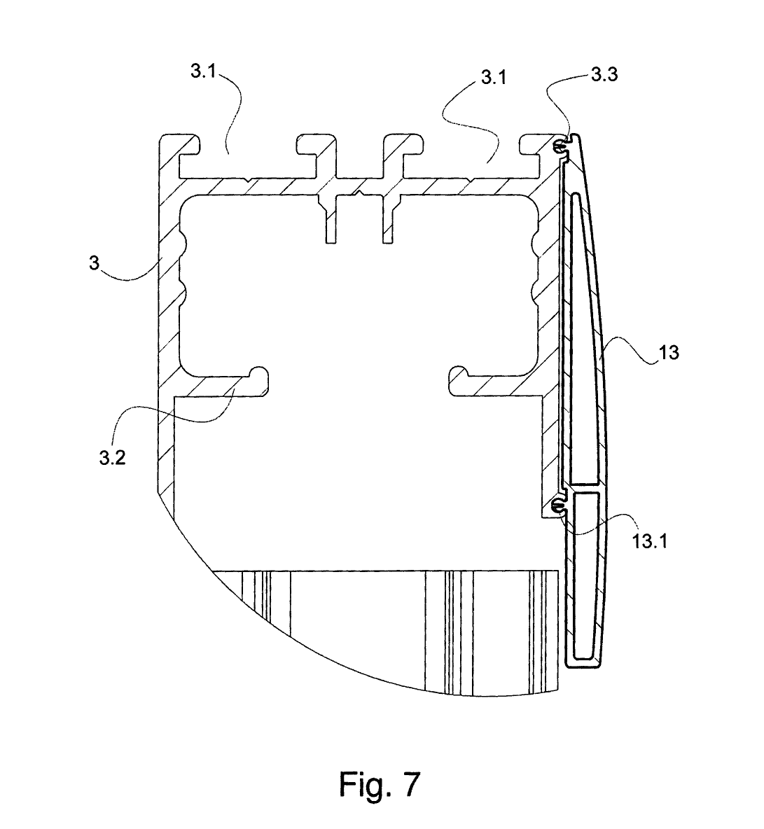

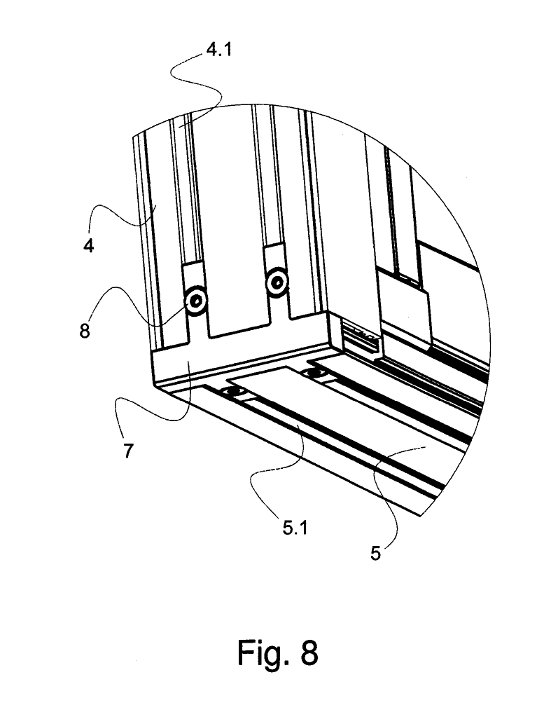

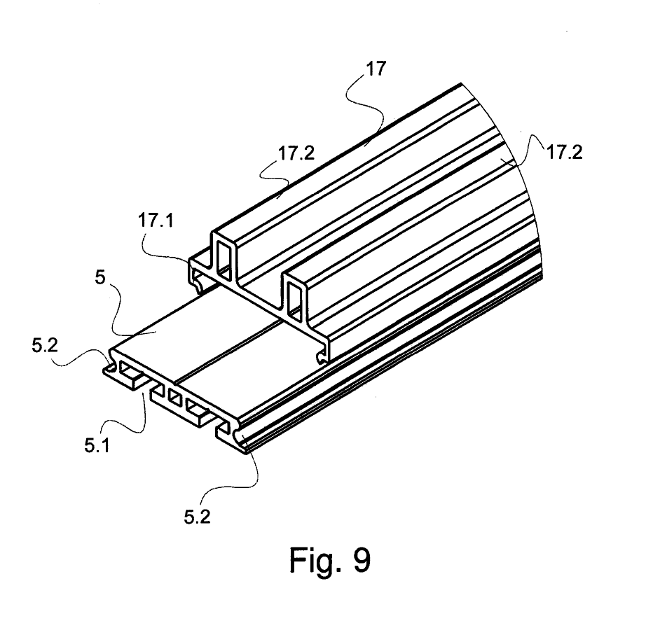

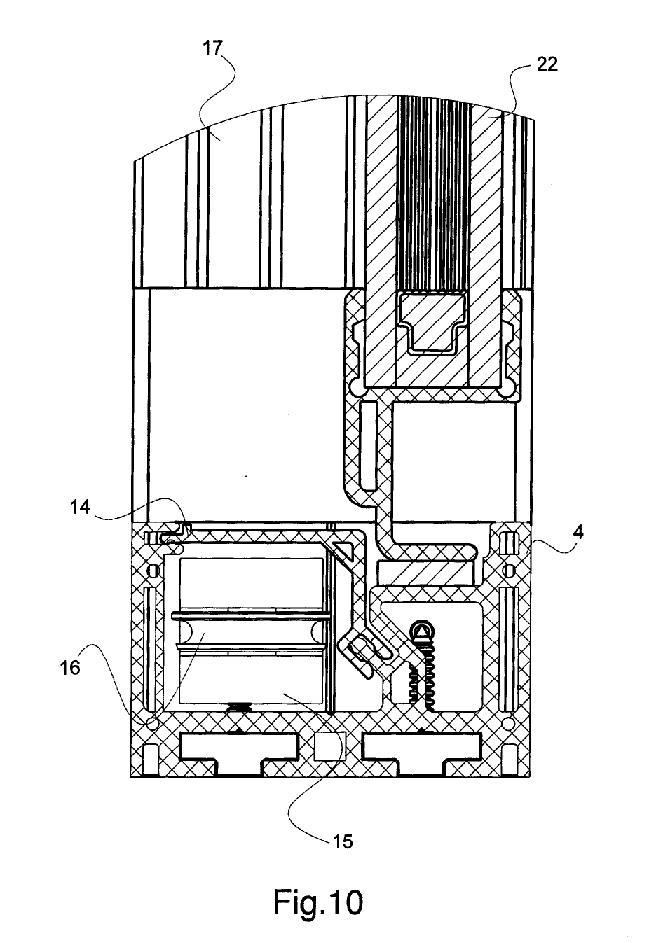

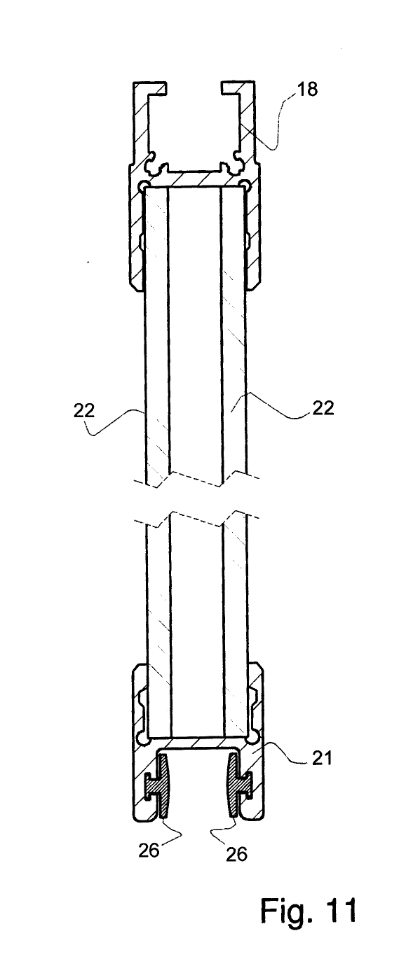

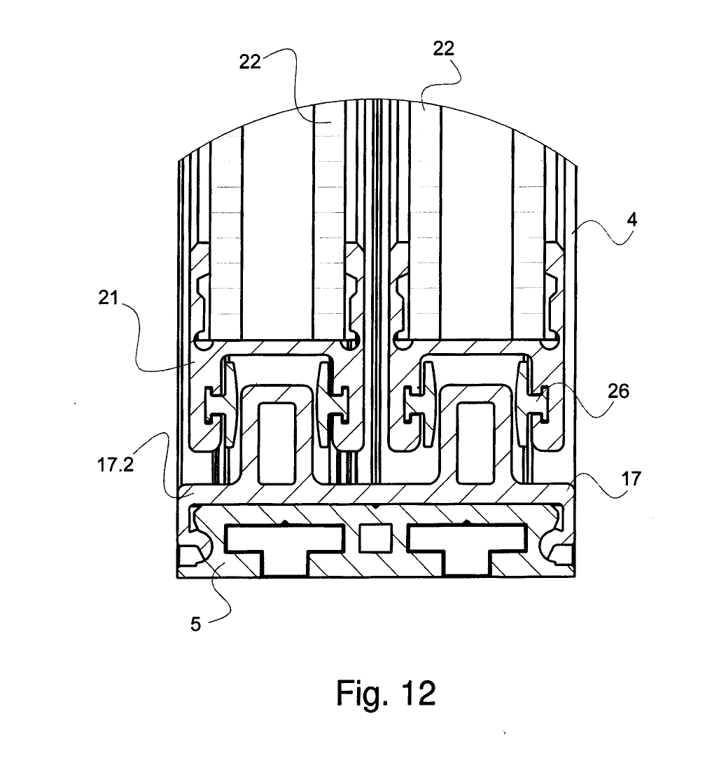

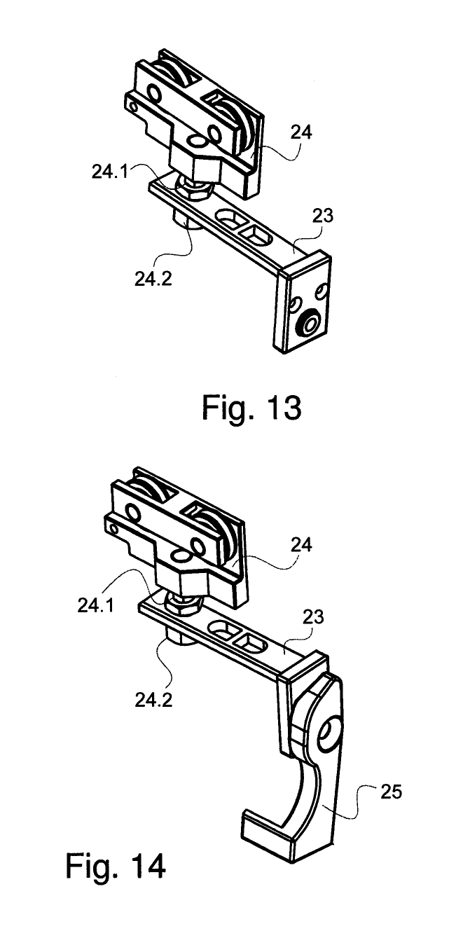

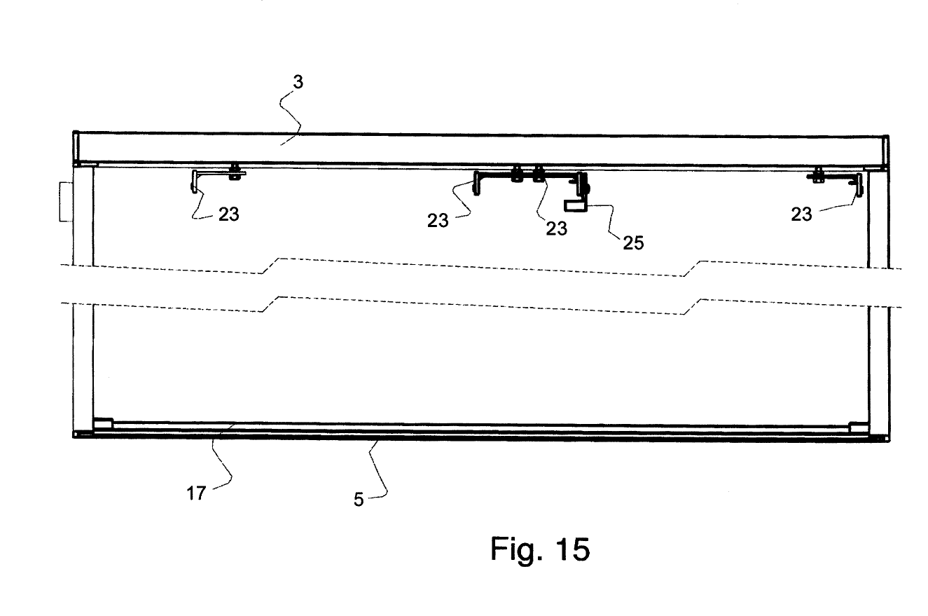

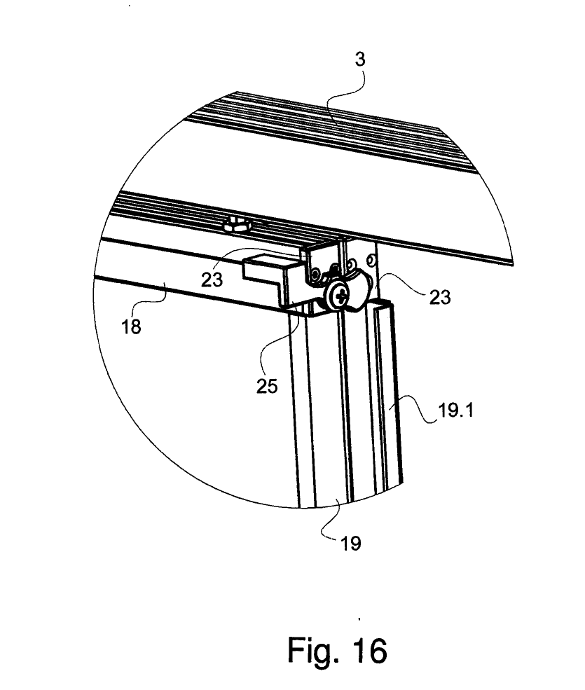

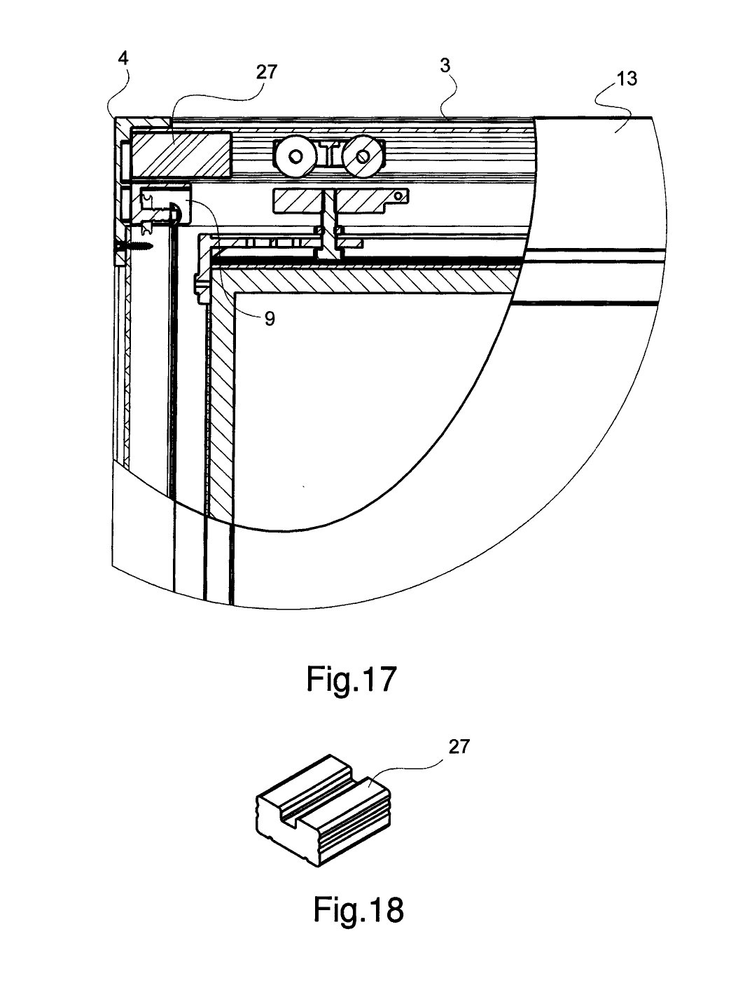

As shown in FIGS. 1-18, two supporting counter-frames 1 according to the invention are installed on a fridge cabinet. The two supporting counter-frames 1 delimit peripherally the access opening to the refrigerated space of the fridge cabinet. Each supporting counter-frame 1 supports two sliding doors 2 closing the display space. The sliding doors 2 of each counter-frame 1 are parallel to each other.

Each supporting counter-frame 1 is composed of a metal supporting upper section bar 3 constituting the upper transom, of two plastic vertical section bars 4 constituting the upright s and of a lower section bar 5 constituting the lower transom. Each section bar 3, 4, 5 of the counter-frame 1 has first guides 3.1, 4.1, 5.1, parallel to its longitudinal axis, along the surface facing the edges of the access opening to the refrigerated space.

Inside the upper section bar 3 there are two arms 3.2, one end of which is enlarged, dividing the inner space of the upper section bar 3 into an upper chamber and a lower chamber. The two chambers communicate with each other. On its side facing the customer, the upper section bar 3 has, moreover, two second guides 3.3, parallel to each other as well as to the longitudinal axis of the upper section bar 3.

Each plastic vertical section bar 4 has two further second guides 4.2, parallel to each other as well as to the axis of the vertical section bar 4, on the surface facing the edges of the access opening to the refrigerated space. Each plastic vertical section bar 4 has further third guides 4.3, parallel to the longitudinal axis of the vertical section bar 4, on the surface facing the access opening to the refrigerated space.

The lower section bar 5 has two further second guides 5.2, parallel to its longitudinal axis, developing along its sides facing the customer as well as the inside of the refrigerated space.

The vertical section bars 4 and the upper section bar 3 are connected to each other by means of connecting angle joints 6, while the vertical section bars 4 and the lower section bar 5 are connected to each other by means of angle brackets 7. Both the upper connecting angle joints 6 and the lower angle brackets 7 are equipped with arms which are inserted into the guides 3.1, 4.1, 5.1 facing the edges of the refrigerated space of the section bars 3, 4, 5 of the counter-frame 1 and fixed to the section bars 3, 4, 5 themselves by means of screws 8.

Each connecting angle joint 6 of the counter-frame 1 houses a box 9 fixed to the connecting angle joint 6 by means of a screw 10. The box 9 houses a first pulley 11 and a second pulley 12. The two pulleys 11, 12 are mounted on rotation axles 11.1, 12.1 arranged orthogonally to each other and fixed to the box 9.

A removable upper covering section bar 13 is fixed on the upper section bar 3. The upper covering section bar 13 is equipped with fins 13.1 housed by means of a snap-in mechanism in the second guides 3.3 of the upper section bar 3, so that the upper covering section bar 13 and the upper section bar 3 can interlock.

A vertical covering section bar 14 is inserted into the third guides 4.3 of each plastic vertical section bar 4. The vertical covering section bar 14 and the walls of the vertical section bar 4 delimit a chamber. This chamber houses a counterweight 15 equipped with a third pulley 16, sliding freely within the chamber itself without any air-retaining element. Said chamber only takes up a part of the inner space of the vertical section bar 4, while the remaining part of the inner space of the vertical section bar 4 is an open chamber, which the sliding door 2 partly enters when it comes to a stop. The chamber within which the counterweight 15 slides and the open chamber for the door stop are parallel to the longitudinal axis of the vertical section bar 4 and are arranged one in front of the other, if observed by someone standing in front of the fridge cabinet. Considering that a sliding door 2 has a more external location than the other sliding door 2, the two vertical section bars 4 housing the corresponding counterweights 15 are mounted reversely: the chamber of the vertical section bar 4, within which a counterweight 15 slides, will be external with regard to someone standing in front of the fridge cabinet, while the chamber of the other vertical section bar 4, within which the other counterweight 15 slides, will be internal with regard to the same person.

A lower covering section bar 17 equipped with perimetric fins 17.1, housed by means of a snap-in mechanism in the side guides 5.2 of the lower section bar 5, is inserted above the lower section bar 5 itself. Along its upper side, the lower covering section bar 17 has guides 17.2 which can guide the sliding doors 2 along their sliding axis. The side guides 5.2 of the lower section bar 5 are over-dimensioned if compared with the size of the fins 17.1 of the lower covering section bar 17. When the two section bars 5, 17 are coupled to each other, there is thus a gap between the lower section bar 5 and the fins 17.1 of the lower covering section bar 17. Any thin metal element, even a coin, can be inserted into said gap, so that, by means of a torsional force on said element, the lower covering section bar 17 can be detached from the lower section bar 5. It is thus possible to wash the lower covering section bar 17, ensuring its cleanliness.

Each sliding door 2 comprises a frame composed of a metal upper supporting section bar 18, of two plastic vertical section bars 19, 20, of a lower section bar 21 and of two plates 22. The upper section bar 18 and the lower section bar 21 have an H-shaped section, with two arms encircling respectively the upper ends and the lower ends of the plates 22. The plastic vertical section bars 19, 20 are also equipped with two arms encircling the side ends of the plates 22. One of the vertical section bars 19 also comprises a U-shaped arm, which can catch the sliding door 2 to move it. The section bars 18, 19, 20, 21 composing the frame of the sliding door 2 are connected to the plates 22 by means of glue. Brackets 23 are fastened to the upper section bar 18 by means of screws 23.1.

A trolley 24 is fixed to each of the brackets 23 by means of a screw 24.1 and a nut 24.2. The trolleys 24 slide by means of wheels on the enlarged ends of the arms 3.2 of the upper section bar 3 of the counter-frame 1.

A rotating locking lever 25 of the sliding doors 2 is pivoted onto a bracket 23 of a sliding door 2, precisely onto the bracket 23 being furthest from the counterweight 15. The locking lever 25 is placed vertically, before the sliding doors 2 are moved by the customer.

The lower section bar 21 of the frame of the sliding door 2 is equipped with anti-friction slides 26. The lower section bar 21 and the corresponding slides 26 slide along the guides 17.2 of the lower covering section bar 17 of the counter-frame 1.

Each counter-frame 1, moreover, is equipped with elastic stop buffers 27. Said buffers 27 are inserted into the upper section bar 3 close to a vertical section bar 4.

One end of a motion transmission cable 28 is fixed to the trolley 24 being closest to the sliding door 2 closest to a vertical section bar 4 of the counter-frame 1 by means of a ring 28.1 locked by a screw. The cable 28 then enters the box 9, slides on the first pulley 11, rotates 90° to slide on the second pulley 12, rotates 90° again to exit the box 9 and slides on the third pulley 16 located on the counterweight 15, enters the box 9 again and the second end of the cable 28 is fastened to the rotation axle 12.1 of the second pulley 12.

Operationally, the sliding door 2 slides manually by means of the trolleys 24, thus making the corresponding part of the display opening of the fridge cabinet accessible. By moving away the trolley 24, onto which the cable 28 is fixed, from the vertical section bar 4 of the counter-frame 1, the cable 28 slides on the first pulley 11, on the second pulley 12 and on the third pulley 16, thus lifting the counterweight 15. The part of the cable 28, going from its first end fixed to the trolley 24 to the first pulley 11, moves along a horizontal line being longitudinal to the sliding door 2. In the section going from the first pulley 11 to the second pulley 12, the cable 28 is horizontal and perpendicular to the surface of the sliding door 2. In the section going from the second pulley 12 to the second end of the cable 28, said cable goes through the third pulley 16 and is vertical and orthogonal to the sliding direction of the sliding door 2. When the sliding door 2 is released, it is closed by means of the counterweight 15 acting in opposition to the weight force of the sliding door 2 itself.

By rotating the above-mentioned locking lever 25 by 90°, one of its ends engages the bracket 23 of the second sliding door 2. In this situation, the forces exerted by the two counterweights 15 of the two sliding doors 2 cancel each other out, because they are equal and opposed, and the two sliding doors 2 are no longer pulled back to their closed position. This makes it possible to move the two sliding doors 2 at the same time from left to right and the other way round in order to gain easy access to the display opening to load and unload the goods. At the end of the operation, one needs only rotate the locking lever 25 to release one sliding door 2 from the other sliding door 2, so that they are again subjected to the force of the corresponding counterweights 15 and are thus closed again.

The two counter-frames 1 of the fridge cabinet are connected to each other by placing them precisely side by side and by exerting pressure to insert pins 29 into the second guides 4.2 of the plastic vertical section bars 4 of the counter-frames 1 themselves.

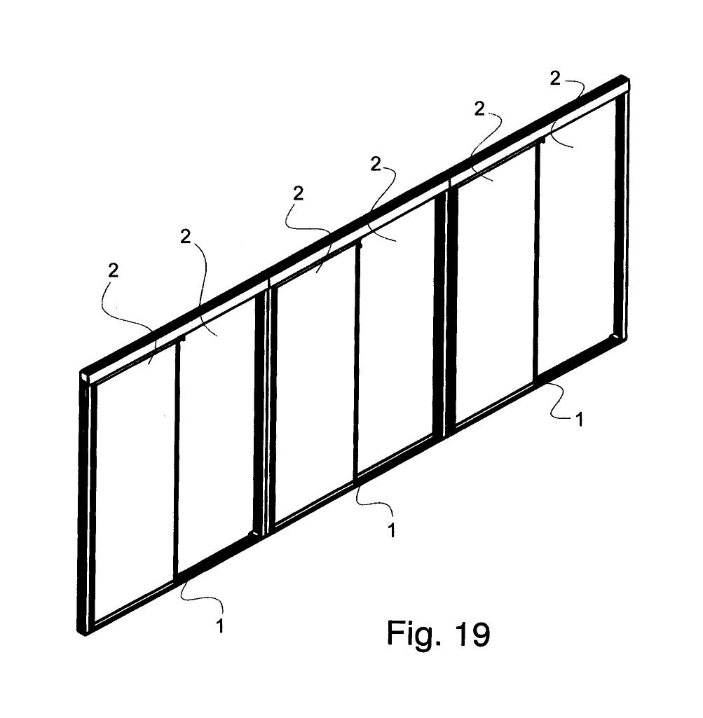

Similarly, it is possible to use this kind of counter-frames 1 on a longer fridge cabinet, such as the one shown in FIG. 19. Together, the three counter-frames 1 shown encircle the whole access opening to the refrigerated space.

1. A supporting counter-frame for sliding doors of fridge cabinets comprising an automatic closing system supporting two sliding doors (2), parallel to each other and sliding freely on the supporting counter-frame (1), sustained by means of trolleys (24) above and guided by lower guides (17.2) below; one of the above-mentioned trolleys (24) is fixed onto each bracket (23) connecting the upper supporting section bar (18) to a vertical section bar (19, 20) of the sliding door (2); said automatic closing system comprises, for each sliding door (2), a first pulley (11), a second pulley (12), a counterweight (15) and a motion transmission cable (28); the first pulley (11) and the second pulley (12) are mounted onto rotation axles (11.1, 12.1) arranged orthogonally to each other; one end of the motion transmission cable (28) is fixed to a trolley (24) of the sliding door (2); each counter-frame (1) is composed of an upper supporting section bar (3), of two vertical section bars (4) and of a lower section bar (5); the vertical section bars (4) and the upper section bar (3) of the counter-frame (1) are connected to each other by means of connecting angle joints (6), while the vertical section bars (4) and the lower section bar (5) of the counter-frame (1) are connected to each other by means of angle brackets (7); said supporting counter-frame (1) is characterized in that the first pulley (11) and the second pulley (12) of the automatic closing system of each sliding door (2) are housed in a box (9) and rotate on said rotation axles (11.1, 12.1) fixed to the box (9) itself; said box (9) housing the first pulley (11) and the second pulley (12) is housed in and fixed to a connecting angle joint (6) linking the upper section bar (3) to a vertical section bar (4) of the counter-frame (1); the counterweight (15) of each sliding door (2) is equipped with a third pulley (16); each counterweight (15) and its third pulley (16) are housed inside a vertical section bar (4) of the counterweight (1) and slide freely within it;
one end of the motion transmission cable (28) is fixed to the trolley (24) being closest to the sliding door (2) closest to the box (9) housing the two pulleys (11, 12) and slides till the first pulley (11) along the sliding direction of the sliding door (2); the motion transmission cable (28) slides from the first pulley (11) to the second pulley (12) horizontally and orthogonally to the sliding movement of the sliding door (2); the motion transmission cable (28) slides from the second pulley (12) to the third pulley (16); the motion transmission cable (28) encircles the third pulley (16) and its other end is fixed to the axle (12.1) of the second pulley (12); the motion transmission cable (28) slides from the second pulley (12) to the third pulley (16) and again to the second pulley (12) vertically and orthogonally to the sliding movement of the sliding door (2).

2. The supporting counter-frame for sliding doors, according to claim 1, characterized in that each section bar (3, 4, 5) composing the counter-frame (1) has first guides (3.1, 4.1, 5.1), parallel to its longitudinal axis, along the surface facing the edges of the access opening to the refrigerated space; both the upper connecting angle joints (6) and the lower angle brackets (7) are equipped with arms inserted into the above-mentioned first guides (3.1, 4.1, 5.1) of the section bars (3, 4, 5) composing the counter-frame (1) and fixed to the section bars (3, 4, 5) themselves.

3. The supporting counter-frame for sliding doors, according to claim 1, characterized in that inside the upper metal section bar (3) of the counter-frame (1) two arms (3.2) dividing the inner space of the upper section bar (3) into an upper chamber and a lower chamber of the upper section bar (3) itself, in which the two chambers communicate with each other; said trolleys (24) supporting the sliding doors (2) slide by means of wheels on the arms (3.2) of the upper section bar (3); said upper section bar (3) has, moreover, further second guides (3.3), parallel to each other and to the longitudinal axis of the upper section bar (3), on its side facing the customer.

4. The supporting counter-frame for sliding doors, according to claim 1, characterized in that a removable upper covering section bar (13) is fixed on the upper section bar (3); said upper covering section bar is equipped with fins (13.1) housed by means of a snap-in mechanism in the second guides (3.3) of the upper section bar (3), thus making it possible to connect the upper covering section bar (13) and the upper section bar (3).

5. The supporting counter-frame for sliding doors, according to claim 1, characterized in that each vertical plastic section bar (4) has further second guides (4.2), parallel to each other and to the longitudinal axis of each vertical section bar (4), on the surface facing the edges of the access opening to the refrigerated space; said second guides (4.2) of the vertical section bars (4) house pins (29) which can connect two adjacent counter-frames (1) to each other.

6. The supporting counter-frame for sliding doors, according to claim 1, characterized in that each vertical section bar (4) has further third guides (4.3), parallel to the longitudinal axis of the vertical section bar (4), on the surface facing the access opening to the refrigerated space; a covering vertical section bar (14) is inserted into the third guides (4.3) of each vertical plastic section bar (4); said vertical covering section bar (14), together with the walls of the vertical section bar (4), delimits a chamber housing the counterweight (15).

7. The supporting counter-frame for sliding doors, according to claim 1, characterized in that the chamber of the vertical section bar (4) housing the counterweight (15) only takes up a part of the inner space of the vertical section bar (4), while the remaining part of the inner space of the vertical section bar (4) is composed of an open chamber, which the sliding door (2) partly enters when it comes to a stop; said chamber, within which the counterweight (15) slides, and said open chamber for the door stop are parallel to the longitudinal axis of the vertical section bar (4) and are arranged one in front of the other, if observed by someone standing in front of the fridge cabinet.

8. The supporting counter-frame for sliding doors, according to claim 1, characterized in that each lower section bar (5), made of plastic or metal material, has further second guides (5.2), parallel to its longitudinal axis and developing along its sides facing the customer and the inside of the refrigerated space; said guides (5.2) are engaged by perimetric fins (17.1) of a lower covering section bar (17) located in a higher position than the lower section bar (5); said lower covering section bar (17) is made of plastic or metal material; said side guides (5.2) of the lower section bar (5) are over-dimensioned if compared with the size of the fins (17.1) of the lower covering section bar (17); the upper side of said lower covering section bar (17) is equipped with the above-mentioned guides (17.2), which are suitable to guide the lower section bar of the frame of each sliding door (2) along its sliding axis.

9. The supporting counter-frame for sliding doors, according to claim 1, characterized in that one rotating locking lever (25) of the sliding doors (2) is pivoted onto a bracket (23) fixed to the upper section bar (18) of the frame of the sliding door (2) and to a trolley (24), more precisely to the bracket (23) being furthest from the counterweight (15).

10. The supporting counter-frame for sliding doors, according to claim 1, characterized in that the lower section bar (21) of the frame of the sliding door (2) is equipped with anti-friction slides (26).

11. The supporting counter-frame for sliding doors, according to claim 1, characterized in that each counter-frame (1) is equipped with stop buffers (27), made of elastic material, inserted into the upper section bar (3) close to a vertical section bar (4).
